(19) United States
(12) Patent Application Publication
(10) Pub. No.: US 2012/0149574 A1
(43) Pub. Date: Jun. 14, 2012

(54) Methods and Compositions for Managing Water Quality in a Body of Water

(76) Inventor: Tyler J. Koschnick, Westfield, IN (US)

(21) Appl. No.: 13/290,029

(22) Filed: Nov. 4, 2011

Related U.S. Application Data
(60) Provisional application No. 61/410,144, filed on Nov. 4, 2010.

(51) Int. Cl. A01N 59/20; B32B 1/02; A01P 13/00

(52) U.S. Cl. 504/152; 428/34.1

(57) ABSTRACT

Described are compositions and methods for application to a body of water to manage water quality therein. The compositions and methods involve the use of a combination of aluminum sulfate and copper sulfate formulated for rapid release in the body of water. Simple compositions and facile methods are made available which balance algae control and phosphorous depletion to improve or maintain water quality while not unduly upsetting other chemistries of the body of water.

### REFERENCE TO RELATED APPLICATION

This application claims the benefit of U.S. Provisional Patent Application Ser. No. 61/410,144 filed Nov. 4, 2010, which is hereby incorporated by reference in its entirety.

### BACKGROUND

The present invention relates generally to water quality management, and in particular embodiments to the management of algae and phosphorous in a body of water using compositions comprising aluminum and copper, such as aluminum sulfate and copper sulfate, respectively.

Green algae and/or cyanobacteria (also known as blue-green algae) growth commonly degrades water quality in bodies of water such as ponds, lakes, and rivers. The aggressive growth of algae can not only result in undesired surface films and lack of water clarity, but also deplete the oxygen resources of the water, potentially causing harm to other aquatic organisms such as fish or invertebrates. The presence of high levels of dissolved phosphorus, due to surface water run-off or other input sources, provides algae with a necessary nutrient supply and often leads to algae blooms or otherwise undesired levels of algae growth.

Treatments to address the presence of algae and favorable conditions for algae growth can themselves be deleterious to water systems, for example by causing an overly rapid kill of algae species leading to a decomposing algae mass that itself depletes oxygen in the water, or by deleteriously altering the chemical balances in the water body. Further, conventional methods of curative algae control, such as applications of copper, in surface water do nothing to mitigate nutrient levels available for sustained algae growth, thus requiring repeated applications for curative management. Further, these applications can re-release available nutrients from dying algae back into the water resulting in rapid utilization of those nutrients and recovery of targeted species.

In light of this and other background in the area, there are needs for simplified methods and compositions for improving water quality in bodies of water and mitigating nutrients while maintaining algae to acceptable levels. Such methods and compositions desirably involve the use of readily- and inexpensively-prepared chemical formulations and applications thereof which balance curative control of undesired algae organisms and removal of causatives for overgrowth or rapid re-growth of such organisms. Certain aspects of the present invention are addressed to these needs.

### SUMMARY

One feature of the present invention relates to the discovery of a composition useful for application to a body of water to manage the water quality of the body of water. In accordance with certain embodiments, the composition includes an aluminum compound, such as an aluminum salt, preferably aluminum sulfate, and a copper compound, such as a copper salt, preferably copper sulfate, desirably formulated to immediately release when the composition is added to the body of water.

Another embodiment of the invention provides a method for managing water quality in a body of water comprising adding to the body of water a composition comprising aluminum sulfate and copper sulfate, desirably formulated to immediately release when the composition is added to the body of water.

Still another embodiment of the invention comprises an article of manufacture comprised of a closed container and an amount of a composition as described herein received in the container. The container can bear written indicia such as a label directing the addition of the composition to a body of water, including for example directions as to a rate, level or amount at which the composition is recommended for addition to the body of water.

Additional embodiments of the invention provide methods for managing water quality comprising adding a copper compound such as a copper salt (e.g. copper sulfate) and an aluminum compound such as an aluminum salt (e.g. aluminum sulfate), desirably each in an immediate release formulation, which can be the same formulation or separate formulations. Such methods can be used to reduce the total algae in a body of water (e.g. as can be measured by chlorophyll a levels), reduce the total phosphorus, and selectively control blue-green algae relative to green algae and potentially maintain or establish an algal assemblage in which green algae are present at a greater density (cells/ml) than blue-green algae.

Still further embodiments of the invention relate to methods for preparing compositions or managing water quality in a body of water, which involve the admixture of aluminum sulfate and copper sulfate to provide a formulation for their release, desirably immediate, when added to the body of water.

In preferred aspects of the compositions, methods, and articles of manufacture described hereinabove in this Summary or elsewhere in this document:

the composition has a ratio of aluminum to copper in the range of about 1:1 to about 1:6.5, more preferably in the range of about 1:2 to about 1:4; and/or

the aluminum compound is aluminum sulfate 14 hydrate; and/or

the copper compound is copper sulfate pentahydrate; and/or

the composition is unbuffered; and/or

the composition consists or consists essentially of the aluminum sulfate and the copper sulfate, optionally in combination with a liquid carrier.

Further, the form of the composition in any of the above compositions, methods or articles of manufacture, can be a solid admixture comprising, at a minimum, the copper sulfate and the aluminum sulfate or a liquid composition provided as a solution of the aluminum sulfate and the copper sulfate; the admixture being alone or in combination with another aquatic herbicide or algaecide and/or potentially other ingredients.

Additional embodiments as well as features and advantages of the invention will be apparent from the descriptions herein.

### DESCRIPTION OF THE FIGURES

FIG. 1 is a graph of chlorophyll a content over time in treated and untreated bodies of water, as described in Example 3 below.

FIG. 2 is a graph of total suspended solids (TSS) over time in treated and untreated bodies of water, as described in Example 3 below.

FIG. 3 is a graph of alkalinity over time in treated and untreated bodies of water, as described in Example 3 below.

FIG. 4 is a graph of pH over time in treated and untreated bodies of water, as described in Example 3 below.

FIG. 5 is a graph of water hardness over time in treated and untreated bodies of water, as described in Example 3 below.

FIG. 6 is a graph of dissolved oxygen over time in treated and untreated bodies of water, as described in Example 3 below.

FIG. 7 is a graph of temperature over time in treated and untreated bodies of water, as described in Example 3 below.

FIG. 8 is a graph of phosphorous content over time in treated and control volumes of water, as described in Example 4 below.

FIG. 9 is a graph of chlorophyll a content over time in separate bodies of water treated with an inventive composition and copper sulfate pentahydrate, respectively, as described in Example 5 below.

FIG. 10 is a graph of turbidity (in Nephelometric Turbidity Units, or “NTU”) over time in separate bodies of water treated with an inventive composition and copper sulfate pentahydrate, respectively, as described in Example 5 below.

FIG. 11 and FIG. 12 are graphs of total phosphorus (TP) and free reactive phosphorous (FRP) over time in respective bodies of water treated with an inventive composition (FIG. 11) and with copper sulfate pentahydrate (FIG. 12), as described in Example 5 below.

FIG. 13 and FIG. 14 are graphs of algae assemblage over time in respective bodies of water treated with an inventive composition (FIG. 13) and with copper sulfate pentahydrate (FIG. 14), as described in Example 5 below.

FIG. 15 is a graph of chlorophyll a content over time in separate bodies of water treated with an inventive composition and copper sulfate pentahydrate, respectively, as described in Example 6 below.

FIG. 16 is a graph of turbidity (in NTU) over time in separate bodies of water treated with an inventive composition and copper sulfate pentahydrate, respectively, as described in Example 6 below.

FIG. 17 is a graph of total phosphorus (TP) over time in separate bodies of water treated with an inventive composition and with copper sulfate pentahydrate, as described in Example 6 below.

FIG. 18 and FIG. 19 are graphs of algae assemblage over time in respective bodies of water treated with an inventive composition (FIG. 18) and with copper sulfate pentahydrate (FIG. 19), as described in Example 6 below.

### DETAILED DESCRIPTION

For the purpose of promoting an understanding of the principles of the invention, reference will now be made to certain embodiments thereof and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

As disclosed above, aspects of the present invention relate to methods, compositions, and articles of manufacture involving the use of copper, such as copper sulfate, and aluminum, such as aluminum sulfate, to treat water for management of water quality including the presence of algae, phosphorous or other properties.

Copper compounds for use in the invention can be obtained commercially or prepared using known techniques. Copper sulfate hydrates will typically be used, and in certain embodiments the copper sulfate used will be copper sulfate pentahydrate. Anhydrous copper sulfate may also be used.

Similarly, aluminum compounds for use in the invention can be obtained commercially or prepared using known techniques. Aluminum sulfate hydrates will typically be used, and in certain embodiments aluminum sulfate 14 hydrate will be used. Anhydrous aluminum sulfate may also be used.

Compositions of and for use in the invention can be in the form of solid mixtures or liquids. For liquid compositions, a liquid carrier, preferably aqueous, will be used. In certain embodiments, the liquid carrier will consist or consist essentially of water. In other embodiments, water can used in conjunction with one or more co-solvents, preferably a co-solvent(s) that is miscible with water such as a polar organic solvent, including but not limited to alcohols such an ethanol. In embodiments where a co-solvent is used, the overall liquid carrier is desirably substantially (greater than 10% by volume) water, preferably 35+ percent by volume water, more preferably at least 50% by volume water, and most preferably at least 80% by volume water.

Where solid formulation compositions are used, the aluminum sulfate and the copper sulfate, including those specific hydrate forms mentioned above or others, can be provided in solid form, desirably as a finally divided particulate, for example a fine ground or rough crystal having an average maximum particle dimension of less than 10 mm, preferably less than 5 mm, more preferably less than 2 mm. The aluminum sulfate and copper sulfate can be mixed together using conventional dry solids mixers to form substantially homogeneous particulate compositions. In some embodiments, the composition will consist or consist essentially of the copper sulfate and the aluminum sulfate materials. In other embodiments, a dry carrier additive can be included, for example an additive (e.g. particulate) that promotes flow of the composition and/or an additive that reduces dusting of the composition.

In desirable solid or liquid formulations of and for use in the invention, there will be less aluminum than copper (considered as metals) on a weight basis in the composition. The weight ratio of aluminum to copper (as metals) is desirably in the range of about 1:1 to about 1:6.5, more preferably 1:2 to 1:4 and most preferably in the range of about 1:2.7 to about 1:3.0. These and all other ratios given in the present document are given in weight ratio, unless otherwise stated or clear in context.

In liquid compositions, it is desired that the liquid composition be substantially concentrated in both aluminum and copper. In this regard, in certain embodiments, the metallic copper content of the overall liquid composition will be at least about 2% by weight, more preferably at least about 4.0% by weight, and in certain embodiments, greater than about 4% by weight. In addition or alternatively, the metallic aluminum content of the overall liquid composition is desirably less than or equal to the metallic copper content of the overall liquid composition, for example, the metallic aluminum content of the liquid composition can be less than about 3% by weight, more preferably less than about 2% by weight, and in certain embodiments in the range of about 0.5% to about 2% by weight. In one particularly preferred embodiment of a liquid composition, the metallic copper content of the composition is about 3.9% to about 4.3% by weight, and the metallic aluminum content of the composition is about 1.3% to about 1.6% by weight.

In certain embodiments of liquid compositions, the pH of the liquid will be below about 5, for example in the range of about 2 to about 4 or in the range of about 2 to about 5. The pH can in certain embodiments be in the range of about 2.5 to about 3.5 or in the range of about 2.6 to about 3.2. In other embodiments, the pH can be in the range of about 3.5 to about 4.5. In particular embodiments, the pH of the liquid composition will be the pH of the aluminum sulfate and copper sulfate ingredients “neat”. The term “neat” in the context means that the pH of the liquid composition is that which is achieved by the presence of the aluminum sulfate and the copper sulfate, without the presence of any buffering agent. Accordingly, unbuffered liquid compositions form embodiments of the invention which can be advantageous in simplifying and/or reducing the cost of treatment of the body of water.

Liquid compositions of and for use in the invention can have densities above about 9.5 lbs per gallon, for example in the range of about 9.5 to about 10.75 lbs per gallon. In certain embodiments, the density of the liquid composition will be about 10 to about 10.5 lbs per gallon.

As noted above, compositions of and for use in the invention can also be provided in the form of mixed solid particulates. In these compositions, the aluminum sulfate and copper sulfate will desirably have particle sizes as specified above. Additionally, the copper sulfate and aluminum sulfate can make up the predominant portion by weight (50+ percent) of the composition, preferably at least 90% by weight of the composition, more preferably at least 95% by weight, and most preferably 99% to 100% by weight of the composition. As noted above, in certain embodiments other solid materials may be in admixture in the composition with the aluminum sulfate and copper sulfate, for example a particulate carrier additive which may improve the flow properties of the composition.

Embodiments of the invention include those in which the composition (liquid or solid) contains at least the ingredients of aluminum and copper, such as aluminum sulfate and copper sulfate. In other embodiments, other ingredients (active and/or inert) can be included, for example selected from among one or more of algicides, phosphorous sequestering or precipitating agents, herbicides or other pesticides, and/or others.

Compositions of and for use in the invention can be prepared in any suitable manner. Dry compositions can be prepared by mixing the dry ingredients to form a substantially homogenous mixture. Liquid compositions can be prepared using any suitable technique or order of addition. In some forms, solid aluminum sulfate and solid copper sulfate can be added together or separately, and in any order, to the liquid carrier to arrive at the desired concentration levels. In other forms, a separate solution of the aluminum sulfate can be combined with a solution of the copper sulfate. In still other forms, a solution of both sulfates can be combined with a solution of one of the sulfates to adjust the relative proportions of the aluminum and copper sulfates in the finished composition. In other forms, solutions comprising dissolved aluminum and copper sulfates may be dried to form a crystallized dry formulation. These and other modes of manufacturing the compositions will be apparent to those of ordinary skill in the art from the descriptions herein.

Solid or liquid form compositions of the invention can be added to a body of water to facilitate management of the quality of the water. The body of water is desirably a freshwater body, for example a lake, pond or stream. Small ponds represent particularly preferred targets for treatment according to the invention, for example ponds having a volume of no greater than about 100 acre-feet. Such ponds or other such small bodies of water are especially susceptible to algal growth and phosphorous accumulation, but it will be understood that in other embodiments the invention can be used in other bodies of water of more significant volume.

Typically, the body of water to be treated will contain algae organisms, including for example one or more of such planktonic or filamentous algae species such as Microcystis, Spirogyra, Anabaena, Hydrodictyon, Tribonema, Ulothrix, Cylindrospermum, Oscillatoria, Lyngbya, Phormidium, Ankistrodesmus, Chlorella, Cladophora, Pithophoka, and others. In certain embodiments, the body of water will contain an undesired level of algae organisms, for example exhibiting significant lack of clarity caused at least in part by algae and/or a substantial algae surface mass or “scum”. In addition or alternatively, the body of water can contain both blue-green algae (cyanobacteria) and green algae. Additionally, the body of water to be treated will often contain undesirable levels of phosphorous and/or will be subject to phosphorous run-off from neighboring terrain, for example adjacent terrain that is treated with a phosphorous-containing fertilizer, and/or to other sources of phosphorous such as atmospheric decomposition, animal inputs, or internal recycling. As noted above, many small freshwater ponds meet one, some or all of these conditions.

In certain forms, the composition of the invention will be added to the body of water targeted to achieve a copper level in the range of about 100 parts per billion (ppb) to about 1000 ppb in the body of water, more preferably about 150 ppb to about 350 ppb; in addition or alternatively, compositions of the invention will be added to the body of water targeted to achieve an aluminum level in the range of about 20 ppb to about 500 ppb, more preferably about 40 ppb to about 160 ppb. In alternate embodiments, a first composition containing the copper compound (desirably an immediate release formulation such as a liquid solution) and a second composition containing the aluminum compound (also desirably an immediate release formulation such as a liquid solution) can be mixed as they are being added to the body of water or separately applied to the body of water, potentially at substantially the same time (e.g. within about a day of each other, preferably within about an hour, and potentially simultaneously) and/or to provide both the copper compound and aluminum compound in the water at the same time. It has been discovered that the use of a phosphorous-depleting aluminum compound in conjunction with a copper compound serving as an algaecide can not only reduce the total algae population but also beneficially modify or maintain an algal assemblage in a body of water such that blue-green algae are selectively controlled relative to green algae. This provides the ability to both reduce the total algae in the body of water and establish or maintain an algal assemblage in the body of water in which the green algae are present in an unexpected higher density (cells/ml) than blue-green algae despite the fact that an opposite assemblage pattern has been seen to occur when using copper alone to reduce total algae. In this regard, as demonstrated in Examples 5 and 6 below, treatment with copper alone can lead to an algal assemblage in which more undesirable blue-green algae dominate drastically, and then continue to dominate in rebound algal growth following treatment. The same is not true in treatment regimens that combine both copper and aluminum compounds, where the green algae are shown to dominate to a greater extent (Examples 5 and 6). Thus, in certain aspects of the invention, an advantageous post-treatment phase can be attained in which the rate of increase of total algae is significantly slowed and during any such increase the green algae (Chlorophyta) dominate the assemblage relative to the cyanobacteria (Cyanophyta). This can in turn enable reduced application over time of algaecidal compounds such as the copper compounds herein and consequently reduced environmental loading with those compounds. It is contemplated within some embodiments of the invention that these and other management goals can be achieved while adding compositions of the invention with combined copper/aluminum compounds, or while adding separate compositions of copper and aluminum. When adding copper and aluminum separately, they can be added in amounts to achieve relative ratios to one another, and concentrations in the body of water, as taught herein for the inventive compositions that combine the copper and aluminum compounds.

In desirable treatment regimens, a composition of the invention will be periodically added to the body of water to be managed, providing a plurality of treatments. For example, the body of water can be treated with an amount of the composition every 1 to 6 weeks, more preferably every 2 to 3 weeks. Overall management courses that include 3 or more treatments, typically 6 or more treatments, will be preferred, and can be dependent on the phosphorus concentration and potential for additional inputs.

Periodic treatment with compositions of the invention will add copper to the body of water to control algae, and will also simultaneously deplete an amount of phosphorous from the water column due to the flocculating activity of the aluminum sulfate in which phosphorus is bound in an insoluble compound form. In this regard, the amount of aluminum in the preferred compositions is relatively low compared to the amount of copper, resulting in a more gradual removal of phosphorous from the water and a lower immediate impact on water chemistry. Over the course of treatments, the water quality will be improved as the algae are controlled and the level of solubilized phosphorous in the water is decreased. Improvements in surface appearance, water clarity (reduction of turbidity), and algae content (as can be measured by chlorophyll a quantitation) can thereby be achieved, and the post-treatment increase in algae content can be significantly slowed or delayed e.g. as compared to corresponding treatments in which copper but not an aluminum flocculent are used. This benefit may also reduce the longer-term need for algaecide use and in particular reduce overall copper loading to the environment, which has been described as a potential chronic exposure hazard for various aquatic organisms. Additionally, the inventive treatment of the body of water can decrease the ratio of the density (cells/milliliter) of blue-green algae (Cyanophyta) to green algae (Chlorophyta) in the body of water. Such changes in the algal assemblage can modify this density ratio so as to convert the water body from one in which the blue-green algae dominate (density blue-green algae>density green algae) to one in which the green algae dominate (density blue-green algae<density green algae).

Addition of compositions of the invention to the water body can be achieved in any suitable fashion. Dry solids can be spread on the surface of the body of water, or blown subsurface, or tank mixed and diluted with water before application to the surface water. Liquid compositions can be added by pouring or spraying the liquid composition to the body of water, either above the surface and/or subsurface, and can be tank mixed and diluted with water before application to the surface water, e.g. in the case of concentrates that can be diluted prior to application to the body of water. Desirably, compositions of the invention will be added above the water surface or subsurface but near the water surface (e.g. within 2 feet of the water surface) so that the aluminum flocculant will release and distribute in the water column to remove phosphorous therefrom. In this regard, compositions of the invention are desirably formulated as immediate release compositions, free from any attached controlled release carrier such as can be achieved when manufacturing pellet, noodle or other composite forms with mineral or other carriers attached to the actives, e.g. smectite minerals such as bentonite. Compositions of the invention can thus be free from any smectite or other mineral, or at least free from any smectite or other mineral attached to the aluminum sulfate or copper sulfate so as to slow or control release of the aluminum sulfate or copper sulfate when added to the water. Liquid compositions in which the aluminum and copper species are dissolved in the liquid carrier are particularly desired for their immediate release, and in the case of dry solid salt compositions as disclosed herein, small particle sizes such as those disclosed herein can facilitate the rapid dissolution (e.g. within about two minutes, or within a few (e.g. 20) seconds) of the salts to achieve the immediate release property such that the action of copper and aluminum commences within the water column to which the composition is delivered as opposed to a delayed action that would not occur until after the solid had sunk to the bottom of the water body. More specifically with regard to liquid compositions of the invention, the preferred formulation more readily and reliably goes into solution with water as compared to solid formulations, where water temperature can impact the solubility and/or rate of dissolution of solid aluminum salts in water.

Compositions of the invention will desirably be packaged within closed containers to provide articles of manufacture of the invention. The closed containers can have written indicia thereon, e.g. on an external surface or label applied thereto, providing instructions for addition of the composition to a body of water. The written indicia can for example include information relating to a rate of application of the composition to a body of water (e.g. correlated to a target concentration of the aluminum and/or the copper (or their corresponding salts) in the body of water, relating to warnings about use of the product, relating to ingredients in the product, or other matters pertinent to use of the product. In certain embodiments, the closed container will be a plastic container such as a bucket or jug, having a removable lid or cap and/or the composition will be a liquid composition as disclosed herein. Such liquid compositions will desirably be solutions that are storage stable within the container when stored at about 20 to 25° C., for example avoiding any significant crystallization for at least 30 days, more preferably at least six months, and most preferably at least a year.

For the purpose of promoting a further understanding of the present invention and features thereof, the following specific Examples are provided. It will be understood that these Examples are illustrative, and not limiting, of the invention.

### Example 1

### Preparation of Liquid Compositions

A commercially available aqueous solution of aluminum sulfate 14 hydrate (47.5% by weight solution) was mixed with a prepared 25% by weight aqueous solution of copper sulfate pentahydrate. The solutions were mixed in a ratio of 34.5% by volume of the aluminum sulfate 14 hydrate solution to 65.5% by volume of the copper sulfate pentahydrate solution. The resulting liquid solution had a density of 10.4 pounds per gallon, and a pH of ˜2.8. The composition of the liquid composition was:

| | Grams per 100 |
|---|---|
| Component | grams composition |
| Copper sulfate pentahydrate (CSPH): | 16.38 |
| Aluminum sulfate 14 hydrate (AS14H) | 16.38 |
| Water | 67.24 |

The copper metal content (from CSPH) was 4.1 grams per 100 grams of composition (4.1% by weight) and the aluminum metal content (from AS14H) was 1.48 grams per 100 grams of composition (1.48% by weight). The solution, when placed in a closed inert plastic container is stable to storage at about 25° C., exhibiting no significant crystal fallout for at least 12 months.

### Example 2

### Preparation of Additional Compositions

The general preparative procedure of Example 1 is repeated to prepare compositions according to Table 1 below. The compositions are also stable to storage at about 25° C., exhibiting no significant crystal fallout for at least 12 months.

TABLE 1

| Ratio of salts (Cu/Al) | 30/70 | 40/60 | 60/40 | 70/30 |
|---|---|---|---|---|
| Copper sulfate pentahydrate (% of | 9.83 | 13.10 | 19.66 | 22.93 |
| composition) | | | | |
| Aluminum sulfate 14 hydrate (% of | 22.93 | 19.66 | 13.10 | 9.83 |
| composition) | | | | |
| Water (% of composition) | 67.24 | 67.24 | 67.24 | 67.24 |
| | 100 | 100 | 100 | 100 |
| Cu metal (from CSPH, % of | 2.48 | 3.30 | 4.95 | 5.78 |
| composition) | | | | |
| Al metal (from AS14H, % of | 2.06 | 1.77 | 1.18 | 0.88 |
| composition) | | | | |
| Total salt (% of composition) | 32.76 | 32.76 | 32.76 | 32.76 |

### Example 3

### Pond Treatment

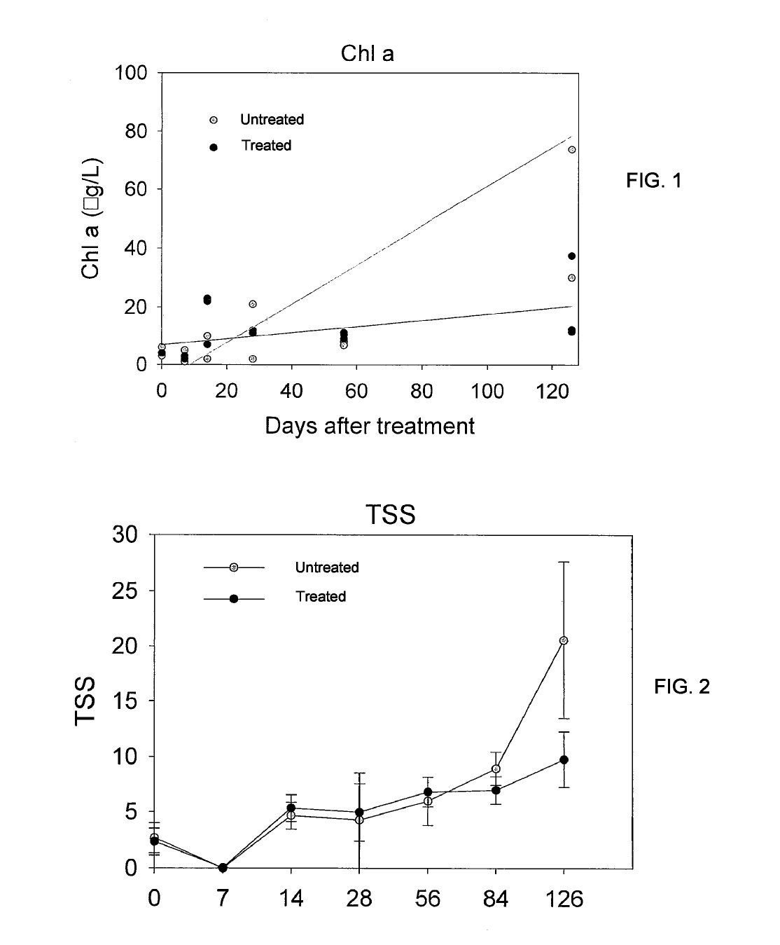

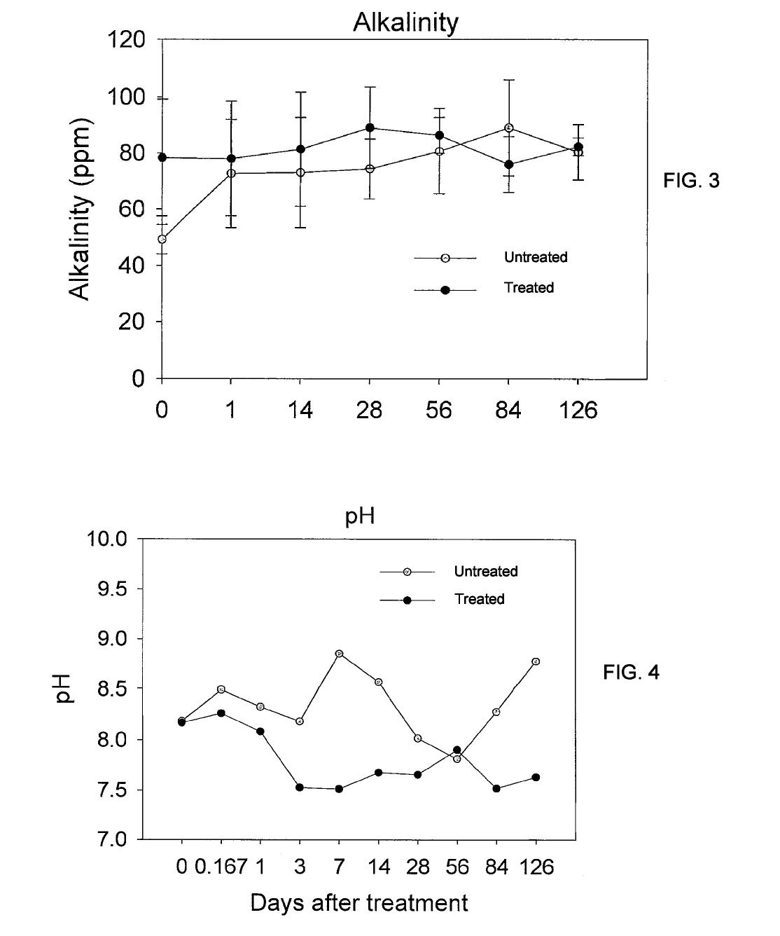

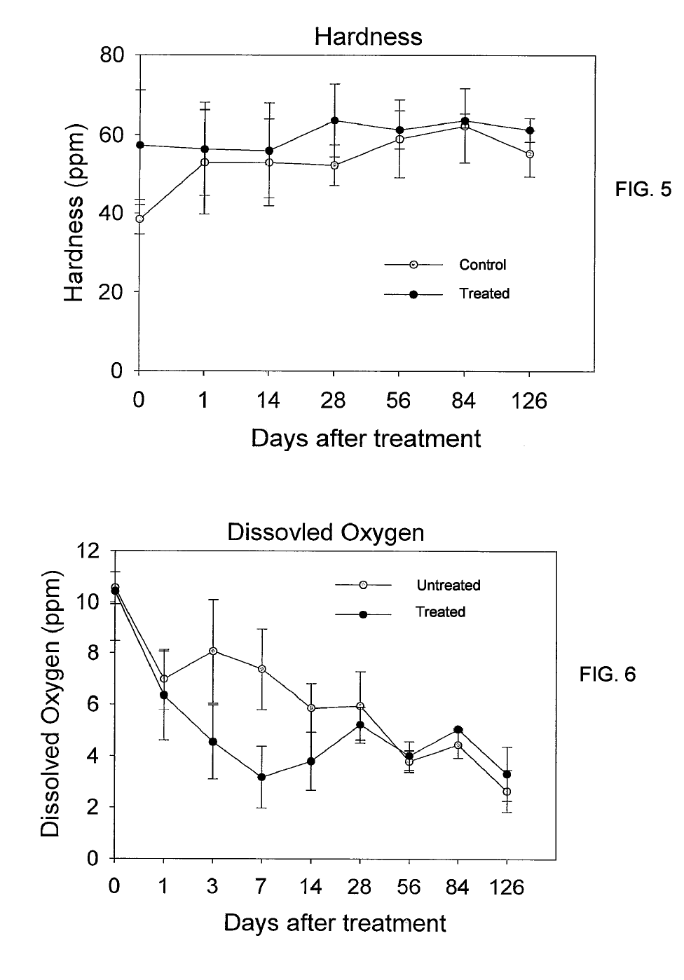

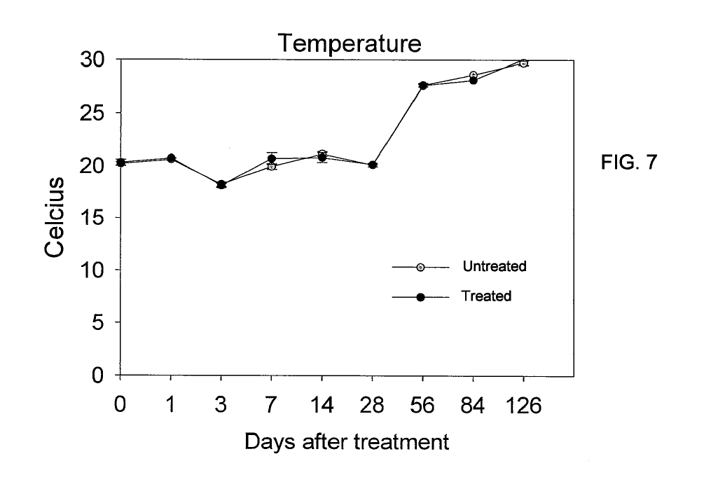

Six ponds of similar condition and size were used in a trial of compositions of the invention. The ponds each had a size of about 0.15 acres. A first set of the ponds (3) were treated every two weeks with a composition as in Example 1 at a rate of 200 ppb copper, over a period of 16 weeks. A second set of the ponds (3) were left untreated. Water samples were periodically taken from the ponds and measured for chlorophyll a content and total suspended solids (TSS). The results are shown in FIGS. 1 and 2, respectively. FIG. 1 demonstrates that the chlorophyll a content for the untreated reference pond increased dramatically, reflecting a rapid and aggressive proliferation of algae over time, whereas the chlorophyll a content of the treated pond increased slightly, representing an effective control of algae growth when compared against the untreated reference pond. FIG. 2 shows that the TSS of the treated pond was lower after the treatment course than that of the untreated pond, resulting in a reduction in the turbidity of the water. Additional measurements were taken of the water samples, including alkalinity, pH, hardness, temperature and dissolved oxygen. The results are shown in FIGS. 3-7, and demonstrate that the treatments, while effective to control algae and reduce TSS, did not exhibit deleterious effects on these other aspects of water chemistry other than those parameters that would be expected to change as a result of more algae growth in untreated ponds that affect water quality due to processes associated with photosynthesis (such as higher dissolved oxygen and lower pH).

### Example 4

### Phosphorous Depletion Testing

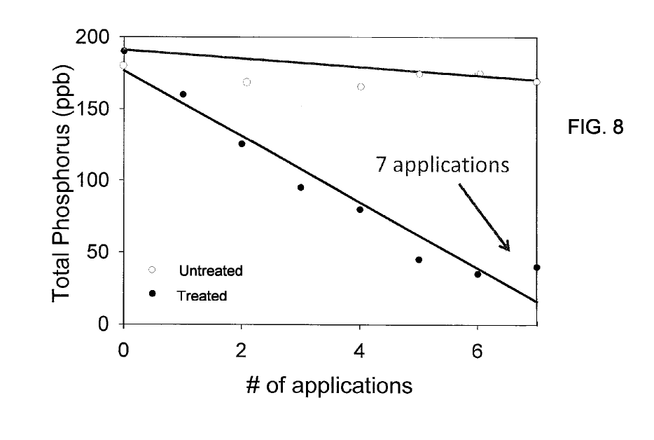

240 liter tanks were filled with well water, and potassium phosphate was added to each tank at 100 parts per billion phosphorus. A composition as in Example 1 was added to the tanks at a rate of 500 ppb copper every day, to simulate the effect on phosphorus following repeated applications of the composition over a compressed period of time. Other similar tanks were left untreated. Samples were collected after each treatment and analyzed for total phosphorous content. The results are shown in FIG. 8, and demonstrate that the inventive composition effectively depletes phosphorous from the water, reducing the total phosphorus gradually after each application.

### Example 5

### Comparative

### Vs. Copper Sulfate Alone Multiple Applications

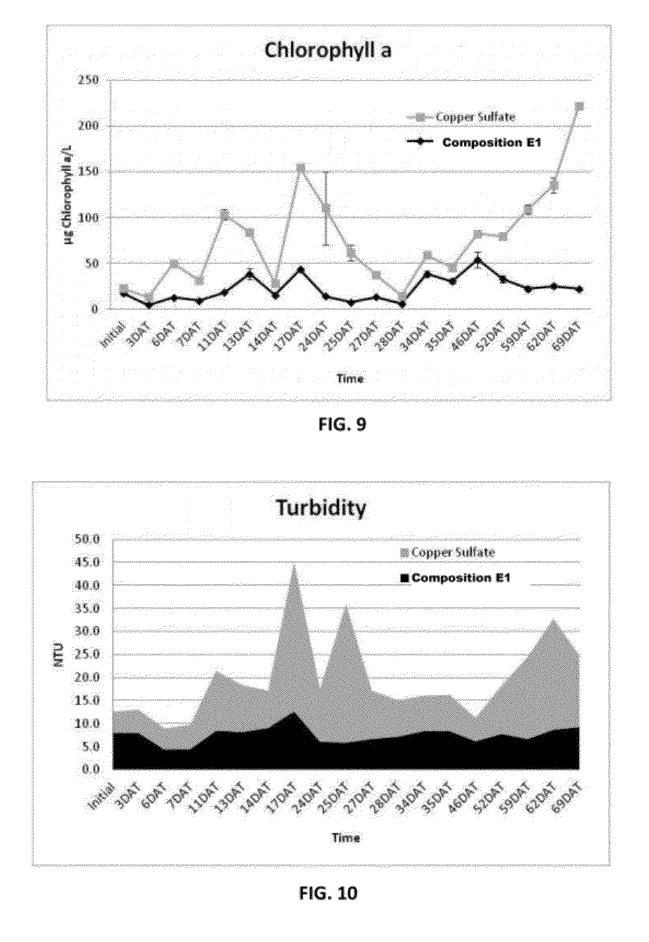

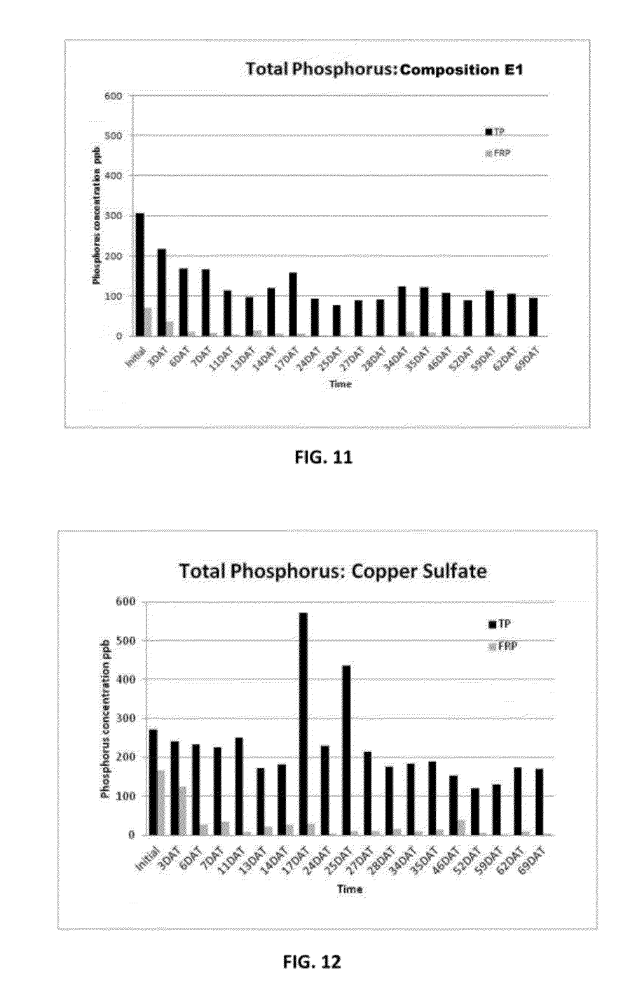

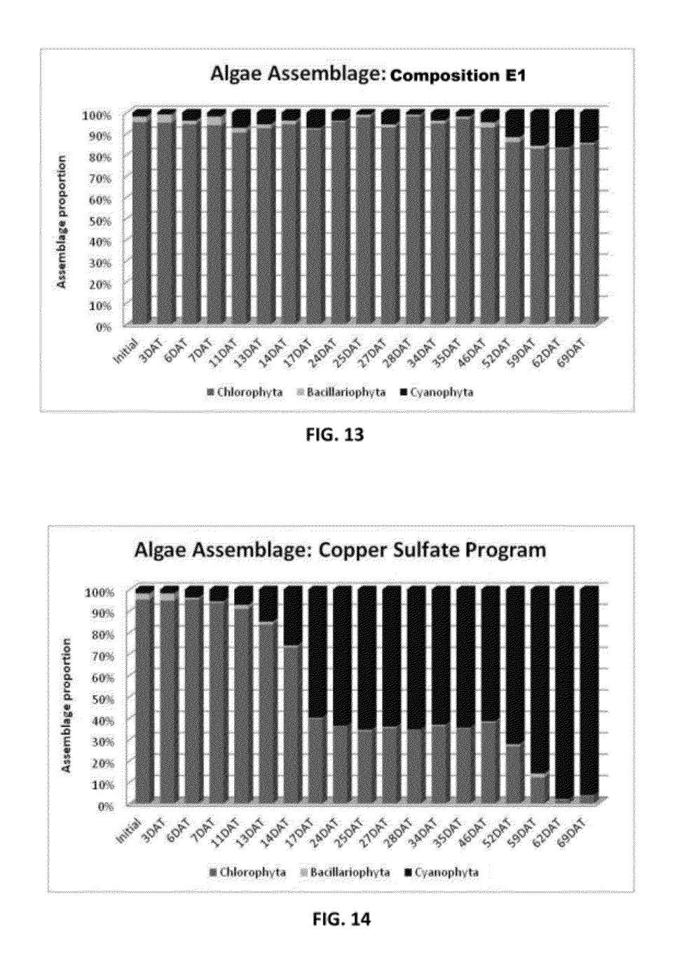

Two ponds of similar dimensions (0.1 surface acres, 4 foot average depth) were used in a treatment program to evaluate responses of water quality parameters and algae types through time. One pond was treated with a liquid composition prepared as in Example 1 (hereinafter termed “Composition E1”) and the other with copper sulfate pentahydrate. Both ponds were treated with the same concentration of copper on the same days. Five algaecide applications, each approximately one week apart, were conducted on the corresponding pond as a surface spray. The first application was a 1 ppm copper rate, whereas the following applications were all 0.5 ppm copper. All five treatments were completed by the 34th day following the initial treatment (“DAT”), though water sampling continued to evaluate changes in algae growth and water clarity. Representative water samples were periodically collected from each of the ponds at the same durations following treatments. FIG. 9 shows that the chlorophyll a concentration in the copper sulfate treated pond was significantly higher than the pond treated with Composition E1 at most sampling periods and had a much more dynamic fluctuation with many measurements exceeding 100 μg/L whereas Composition E1 only experienced 50 μg/L on one occasion. This supports more effective control and suppression of algae growth and overall pond aesthetic improvement (less green water coloration) with Composition E1. Also, following cessation of the algaecide treatments, the copper sulfate pond rapidly and significantly increased in chlorophyll levels while the pond treated with Composition E1 remained relatively constant with little to no chlorophyll increase from algal re-growth. FIG. 10 shows turbidity levels in the copper sulfate treated pond were consistently higher than the Composition E1-treated pond. The Composition E1-treated water clarity was better overall throughout the treatment program and following completion of the treatment program, with only one measurement exceeding 10 NTU. The copper sulfate-treated pond was more turbid at all sampling events and had degraded water clarity. FIG. 11 shows total phosphorus (TP) and free reactive phosphorus (FRP) concentrations in the Composition E1-treated pond. Following application of Composition E1, significant decreases were observed for both TP and FRP and continued to decrease throughout the treatment program. Overall reduction of TP was approximately 70% with Composition E1 e.g. when comparing the TP level at the end of the experiment (69 DAT) to the Initial day TP. With the copper sulfate treated pond, much more dynamic fluctuations of phosphorus were observed and overall TP levels were substantially higher than the Composition E1-treated pond (FIG. 12). FIGS. 13 and 14 show strong differences in the algal assemblages composition between the two ponds. While immediately reducing nuisance and potentially harmful algal densities with treatment, Composition E1 was able to promote and maintain an algae community dominated by green algae (Chlorophyta) even after applications ceased, whereas even within the copper sulfate treatment program, toxin/taste and odor producing cyanobacteria (Cyanophyta) became dominant and continued to dominate following cessation of applications. There was no deleterious effect on water quality or observation of fish toxicity following application of Composition E1. As mentioned previously, when used alone, alum is generally applied at such high doses that a buffer is concurrently applied to prevent dramatic changes in water quality that can result in acute toxicity to aquatic organisms. Composition E1 can be applied in a programmatic approach in which no such buffer is needed.

### Example 6

### Comparative

### Vs. Copper Sulfate Alone Single Application

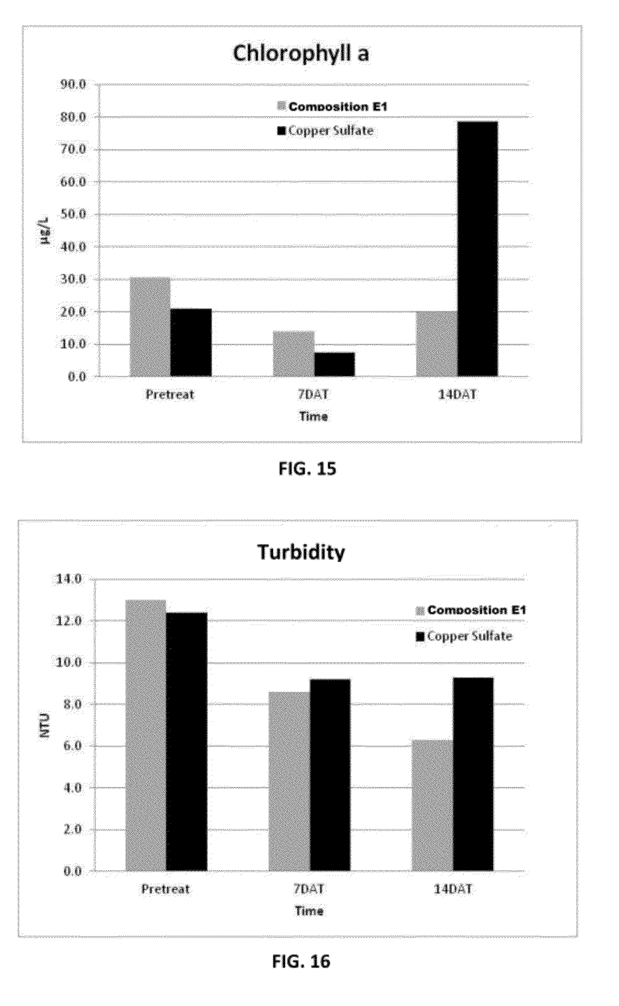

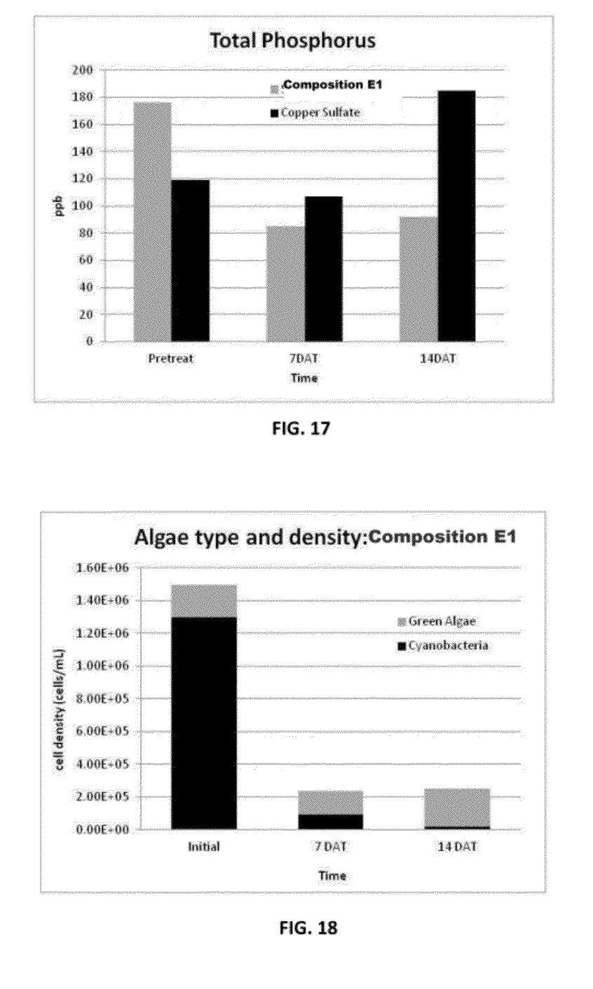

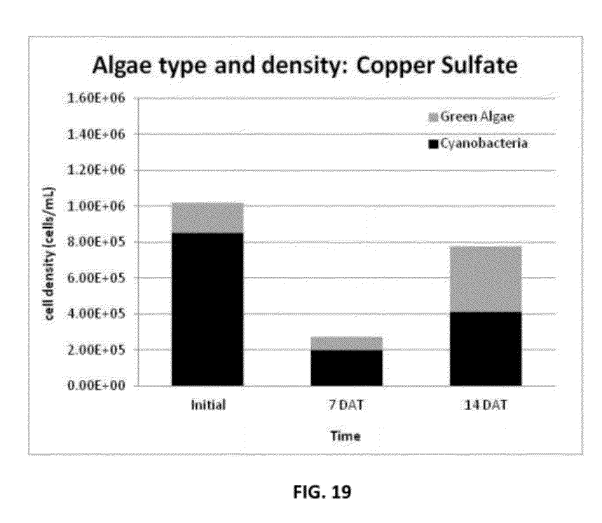

Two ponds of similar dimensions (0.1 surface acres, 4 foot average depth) and similar water character, located beside each other, were used in this experiment. Both ponds were treated once (immediately following the initial sampling event) with the same concentration of copper, 1 ppm, and monitored through time. One pond was treated with Composition E1 and the other with copper sulfate pentahydrate. The objectives were 1) to evaluate the change in algae assemblage composition, 2) to measure algaecidal impacts and re-growth of algae, 3) to measure changes in phosphorus and turbidity following treatment. Chlorophyll a was significantly decreased in both Composition E1-treated and copper sulfate-treated ponds 7 DAT. 14 DAT results showed significantly higher chlorophyll in the copper sulfate treated pond compared with the Composition E1-treated pond as well as the initial value. 14 DAT chlorophyll levels in the Composition E1-treated pond were maintained below initial levels (FIG. 15). Despite a slightly higher initial value, turbidity levels in the Composition E1-treated pond were below levels in the copper sulfate-treated pond at both 7 and 14 DAT (FIG. 16). These results support an enhanced water clarity and increased duration of control with Composition E1. Total phosphorus was decreased and remained at low levels in the Composition E1-treated pond, whereas with copper sulfate little change was measured 7 DAT and a notable increase from initial levels was measured 14 DAT (FIG. 17). Composition E1 had a greater impact on the treated algae at 7 DAT with an 85% decrease compared with 78% in the copper sulfate treatment. Composition E1 maintained control and low overall algal densities through 14 DAT, whereas copper sulfate had a significant (350%) increase in algal densities between 7 and 14 DAT. These results support an enhanced algaecidal impact and increased duration of control with Composition E1. Following treatment, Composition E1 changed the algal assemblage from cyanobacteria (Cyanophyta) dominated to green algae (Chlorophyta) dominated, copper sulfate remained dominated by cyanobacteria after the treatment (FIGS. 18 and 19).

All publications cited herein are hereby incorporated by reference in their entirety as if each had been individually incorporated by reference and fully set forth.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. A method for managing water quality in a body of water, comprising:
adding a composition to the body of water, wherein the composition comprises aluminum and copper formulated to have a weight ratio of aluminum to copper in the range of about 1:1 to about 1:6.5, and wherein the aluminum and copper are immediately released in the body of water.

2. The method of claim 1, wherein the aluminum is aluminum sulfate 14 hydrate.

3. The method of claim 1, wherein the ratio of aluminum to copper is in the range of about 1: to about 1:6.5.

4. The method of claim 1, wherein the composition is an unbuffered composition.

5. The method of claim 1, wherein the copper sulfate is copper sulfate pentahydrate.

6. The method of claim 1, wherein said adding provides the copper sulfate in an effective algicidal amount in the body of water, and wherein the aluminum sulfate is effective to precipitate phosphorous from the body of water.

7. The method of claim 1, wherein said adding comprises periodically adding an amount of the composition to the body of water.

8. The method of claim 7, wherein said periodically adding comprises adding an amount of the composition to the body of water on at least three occasions each spaced 1 to 6 weeks from the other.

9. The method of claim 1, wherein the composition is a dry admixture comprising copper sulfate and aluminum sulfate.

10. The method of claim 9, wherein the copper sulfate is copper sulfate pentandrate and/or wherein the aluminum sulfate is aluminum sulfate 14 hydrate.

11. The method of claim 1, wherein the composition is a solution of the aluminum sulfate and the copper sulfate in a liquid carrier.

12. A composition for managing water quality in a body of water, the composition comprising aluminum sulfate and copper sulfate formulated to have a ratio of aluminum to copper in the range of about 1:1 to about 1:6.5, and wherein the aluminum sulfate and copper sulfate are formulated to immediately release when the composition is added to the body of water.

13. The composition of claim 12, wherein the aluminum sulfate is aluminum sulfate 14 hydrate.

14. The composition of claim 12, wherein the ratio of aluminum to copper is in the range of about 1:1 to about 1:6.5.

15. The composition of claim 12, wherein the copper sulfate is copper sulfate pentahydrate.

16. The composition of claim 12, wherein the composition is a dry admixture comprising the copper sulfate and the aluminum sulfate.

17. The composition of claim 16, wherein the copper sulfate is copper sulfate pentandrate and/or wherein the aluminum sulfate is aluminum sulfate 14 hydrate.

18. The composition of claim 12, wherein the composition is a liquid composition provided as a solution of the aluminum sulfate and the copper sulfate.

19. The composition of claim 12, wherein the composition is an unbuffered composition.

20. An article of manufacture, comprising:
a closed container; and
a composition received in the container, the composition comprising aluminum sulfate and copper sulfate formulated to have a ratio of aluminum to copper in the range of about 1:1 to about 1:6.5, and wherein the aluminum sulfate and copper sulfate are formulated to immediately release when the composition is added to the body of water.

21. The article of manufacture of claim 20, wherein the composition is a composition according to claim 13.

22. The article of manufacture of claim 20, wherein the container includes attached written indicia visible to a user, the written indicia providing instructions for adding the composition to a body of water.

23. The article of manufacture of claim 22, wherein the instructions include at least one label rate correlated to a concentration of aluminum and/or copper in the body of water.

24. A method for preparing a composition for managing water quality in a body of water, comprising:
combining aluminum sulfate and copper sulfate in a composition effective to immediately release the aluminum sulfate and copper sulfate upon addition of the composition to a body of water.

25. The method of claim 24, wherein the composition is a composition in accordance with claim 1.

26. The method of claim 24, wherein the composition is an aqueous solution of the aluminum sulfate and the copper sulfate, and wherein said combining comprises mixing a solution containing the aluminum sulfate with a solution containing the copper sulfate.

27. A method for controlling algae in a body of water containing blue-green algae and green algae, comprising:
adding to the body of water an aluminum salt and a copper salt so as to establish or maintain an algal assemblage in the body of water in which the density of green algae in cells/ml is greater than the density of blue-green algae in cells/ml.

28. The method of claim 27, wherein the aluminum salt and copper salt are added in separate compositions to the body of water.

29. The method of claim 27, wherein the aluminum salt and copper salt are added in the same composition to the body of water.

30. The method of claim 27, wherein the aluminum salt and the copper salt are immediately released when added to the body of water.

31. A method according to claim 1, wherein the composition is solution of the aluminum sulfate and the copper sulfate, and wherein the solution has a pH of less than about 5.

32. The method of claim 31, wherein the pH of the solution is in the range of about 3.5 to about 4.5.

33. The method of claim 31, wherein the solution is free of any buffering agent to buffer the pH provided by the aluminum sulfate and copper sulfate.

34. The method of claim 31, wherein the composition is constituted at least about 2% by weight of copper.

35. The method of claim 31, wherein the solution is capable of storage at 20 to 25° C. for at least six months without crystal formation.
